(19) United States
(12) Patent Application Publication
(10) Pub. No.: US 2011/0309583 A1
(43) Pub. Date: Dec. 22, 2011

(54) METHOD FOR SEALING A STRUCTURAL JOINT, AND SEALING ELEMENT

(75) Inventors: Dennis Andexer, Schwandorf (DE); Markus Komma, Regenstauf (DE); Helmar Nauck, Berlin (DE); Juergen Hess, Neunburg v. W. (DE)

(73) Assignee: TREMCO ILLBRUCK PRODUKTION GMBH, Bodenwoehr (DE)

(21) Appl. No.: 13/129,642

(22) PCT Filed: Nov. 17, 2009
(86) PCT No.: PCT/EP2009/065264

§ 371 Date: Sep. 6, 2011

(30) Foreign Application Priority Data
Nov. 17, 2008 (DE) 102008057761.8
Jan. 27, 2009 (DE) 102009006204.1
Jun. 26, 2009 (DE) 102009026042.0

(51) Int. Cl. F16J 15/02

(52) U.S. Cl. 277/312; 277/630

(57) ABSTRACT

The invention relates to a method for sealing a structural joint using a sealing element (1) composed of an at least partially open-cell, elastically resilient foam, and to a sealing element. The sealing element is able to expand from a compressed state to a partially or a completely expanded state due to elastic resilience of the foam, and is provided with an expansion-influencing medium. It is proposed that the sealing element (1) is held in a compressed state by the medium, and the expansion of the sealing element is enabled by separate action of heat on the medium.

The invention relates firstly to a method for sealing a structural joint using a sealing element composed of an at least partially open-cell, elastically resilient foam which preferably has an elongated form, the sealing element being able to expand from a compressed state to a partially or a completely expanded state due to elastic resilience of the foam, and being permeated with an expansion-influencing medium.

Sealing elements used in such a method are widely known. These are sealing elements composed, for example, of an open-cell flexible foam such as polyurethane flexible foam, or sealing tapes which in the compressed state are in roll form. The sealing tapes are unrolled and inserted into a structural joint, for example between a window and the reveal. As a result of their permeation with a resiliency-influencing medium, usually also referred to as impregnation, wherein the medium may be an acrylate-based liquid composition, the recovery is delayed. The delay until (theoretical) complete recovery is approximately one-half to one hour. This allows unhindered installation, but results in the desired seal-tightness after the time mentioned elapses.

With regard to the prior art concerning such foam sealing elements, reference is made to DE 10 2006 043 050 A1 and DE 35 44 277 C1, for example. Reference is also made to EP 688 382 B1, for example.

Even if the delayed recovery mentioned in many cases is advantageous with regard to the installation, there is still the problem that this recovery occurs at different rates depending on the environmental conditions, in particular high or low temperature. At high temperatures such as in the summer, the recovery is comparatively rapid, whereas at low temperatures such as in the winter, the recovery is correspondingly slow.

Therefore, options have been sought for intentionally initiating the recovery, i.e., in order to not have to depend on immediately installing the sealing tape removed from the roll or other packaging in order to take advantage of the delayed recovery. To this end, it is known from EP 1 131 525 B1, for example, to accommodate the foam strip, which is nevertheless impregnated for the delayed recovery, in a wrapping film which is formed as a tear-off film. The foam strip does not rebound until after the wrapping film is correspondingly opened, but in this regard is also delayed due to the impregnation mentioned. A refinement in this regard is also known from EP 175 664 A2.

The documents cited above are hereby included in full in the disclosure of the present application, including for the purpose of incorporating features of these documents into claims of the present application, with regard to their disclosure, in particular concerning foam used and/or impregnation agents used and/or dimensions, other embodiments, for example using a self-adhesive surface, and disclosed uses. The described tear-off sealing elements have also attained very great practical importance. However, there is still a need to provide this intentional initiation of the recovery, in particular also a delayed recovery, in a more advantageous manner.

On this basis, according to one aspect the invention is concerned with the object of providing a method for sealing a structural joint using a sealing element, in which the sealing element may be easily inserted and reliably brought to the sealing state.

One possible approach to achieving this object is provided according to a first concept of the invention by means of the subject matter of claim 1, in this case the aim being to hold the sealing element in a compressed state by means of the medium, and enabling the expansion of the sealing element by separate action of heat on the medium. This may involve heat which is generated in the sealing element itself, for example, as discussed further below, by induction or heat conduction. This may also be heat which is separately applied to the sealing element, as also discussed further below, for example using heated air or the like. According to the invention, the medium which permeates the foam, i.e., in particular the impregnating agent mentioned, may be used in such a way that it maintains the compressed state of the sealing tape on its own without further measures, and the sealing tape is able to leave this state only by further special action, namely, a special heating action, and rebounds, preferably with a further delay. In the case of filling a joint, this results in contact with the joint surfaces on both longitudinal sides. This is due in particular to the elastic resiliency of the foam as such as the result of preload, which contributes to the sealing. However, the invention is also realized by additionally promoting the recovery by the special action of heat for a conventional impregnating agent. This is important, for example, when the sealing tapes are installed at very low temperatures.

Further features of the invention are addressed below, also in the description of the figures, often in their preferred association with the concept of the claim explained above; however, they may also be important in an association with only one or more individual features of this claim, or independently, or in another overall concept.

It is preferred that the medium is an impregnation agent provided on an acrylate basis, and the agent is selected to have a high glass transition temperature such that automatic recovery does not take place at room temperature. The previously used impregnation agents for which automatic recovery occurs at room temperature or also therebelow also basically have such an acrylate basis. There are also impregnation agents based on paraffin. As stated above, these impregnation agents in principle may also be used according to one aspect of the invention. A plastics-based medium which is amorphous or partially crystalline is preferably used as impregnation agent. Below the glass transition temperature, the medium is at least very viscous, or practically solid or solid. Above the glass transition temperature there is a rapid decrease in toughness and a rapid decrease in viscosity. As a result, the restoring forces of the foam are able to overcome the cohesive forces of the impregnating agent acting on the cell walls, and the foam is able to begin to rebound. The action of heat is discontinued no later than when a complete rebound is achieved, in any event potentially, i.e., when the sealing force has completely developed in the joint, for example. However, due to the fact that the cells of the foam have thus become larger, i.e., changed from a compressed, preferably flat configuration to a configuration that is developing more in the direction of a spherical shape, and the cell walls have moved apart from one another, the elastic resiliency of the foam or of the sealing strip thus formed is maintained, compared to the previously provided state in full compression. Nevertheless, the impregnating agent or the component of the impregnating agent provided in this regard, for example the acrylate, having the relatively high glass transition temperature once again has a temperature which is below the glass transition temperature after cooling.

The glass transition temperature is preferably selected in such a way that automatic recovery occurs only after the sealing element is heated to 30° C. or higher. It is more preferred when heating to 60°, 70°, or 80° C. or higher is achieved. A realistic upper limit in the approximate range of 120° C. is provided. With regard to the temperature ranges mentioned, all intermediate values are hereby included in the disclosure, in particular in 1° C. steps.

Within the scope of the invention, the glass transition temperature may be determined in various ways. For example, dilatometric, dielectric, dynamic-mechanical, or refractometric measurements may be conducted, for example with the aid of NMR spectroscopy. Within the scope of the present patent application it is particularly preferred to determine the glass transition temperatures mentioned using a method known as the ASTM standard (designation: D 1356-03). The ISO standard method in which the determination is performed using differential scanning calorimetry (DSC) may also be used. The temperature values mentioned here may basically be assigned to any of the named measuring methods. If this should result in a lack of clarity, in any event the measurement should be assigned to the ISO standard method.

With regard to the required heating of the sealing element or in particular of the medium permeating same, various procedures may be carried out. As a first example, air heating using a hair dryer, for example, is possible.

However, the heating is preferably carried out electrically. To this end, it is further preferred that the medium is electrically conductive or in any event contains components which within the meaning of heating are excitable by alternating electromagnetic fields, i.e., inductively. Regardless of how the heating is carried out, these components may be provided in a powder-, soot-, wire-, or film-like form. They are provided in such a way that they are able to take part in the expansion of the sealing element. This may be achieved, for example, using wire portions which are inserted transversely or in the longitudinal extent, or, for superposed or adjacent individual layers, which are held in between, which are optionally able to “migrate.” This may also be achieved using film elements. This results in a corresponding separation in the foam in the region of the film elements. As a whole, the foam may also have a layered construction for this purpose. The separation of the layers may be provided parallel to a flat base surface. However, it may also be provided in the form of a curved surface, for example a surface which undulates in the longitudinal section. The film element, for example an aluminum foil, may be held between the layers using one or more self-adhesive strips. These layers may correspondingly be two or more foam layers. Foam layers extending in the longitudinal direction of the sealing element are suitable. Independently or additionally, the film elements or one continuous film element may also extend in the sealing element in an undulating manner. For example, they may be pressed into the foam in the manner of a punching tool without completely separating same. The film elements may also completely separate the foam, in both cases in the sense of a “lost” punching tool, for example.

Instead of or in addition to a continuous self-adhesive strip, it is possible to leave adhesive dots or adhesive points only between regions of lower adhesive force or preferably adhesive-free regions. The adhesive dots (which refer in particular to a nonround, in particular noncircular, plan view) or adhesive points (which preferably have round, in particular circular, plan views, with the exception of overlaps between individual adhesive points) may also be provided to be isolated in an island-like manner from other adhesive dots or adhesive points. In addition, an embodiment is possible in which connecting lines, which are also formed from adhesive and are thin compared to the adhesive points, are formed between spaced-apart adhesive points. In particular, an adhesive point may be joined to adjacent adhesive points via two or more connecting lines. Three, four, six, or more connecting lines in particular may be used. It is preferred that only one connecting line is always provided between two adhesive points. When in this regard six connecting lines, for example, are provided, this means that one adhesive point is surrounded by six other adhesive points.

The adhesive points or adhesive dots mentioned may on the one hand be applied to a customary carrier material known for self-adhesive strips, for example a fabric strip. This self-adhesive strip on the other hand is connected to the electrical conductor, in particular a film-like electrical conductor. It is further preferred that this configuration is provided on both sides of the electrical conductor. However, these adhesive points may also be provided only on the electrical conductor, in particular the film-like electrical conductor. The same as in the previously described embodiment, a continuous homogeneous adhesive layer may be provided directly on the electrical conductor. In this regard, the electrical conductor is then the carrier material for the adhesive, and at the same time also forms a self-adhesive strip which is adhered to the foam on both sides.

Such an arrangement allows two foam strips held together in this manner by means of the conductive layer, in particular a metallic foil, to be easily split in the region of the adherence. For example, this provides good access to the conductive layer, such as a conductive connection to a power line, for the heating action. Alternatively, a self-adhesive strip which in this regard is at least associated with a longitudinal border strip may be provided with a smaller width. In that case, one or both outer regions of the foam sealing strips are not adhered to one another over the “missing” width region, which may correspond to approximately 1/20 to ⅓ or more of the height of the overall rebounded foam sealing strip. The width information mentioned also includes all intermediate values, in particular for delimitation of the width region mentioned from above and/or below, preferably in steps of 1/40 of the height. Within this meaning, the dot or adhesive point regions may also be provided with a smaller width. This also applies in each case to one or both sides.

For the heating, the elements in question, i.e., in particular wire-like or film-like elements, may be heated by electrical resistance heating.

With regard to the electrically conductive components, or components which within the meaning of heating are excitable by alternating electromagnetic fields, i.e., inductively, metallic components in particular are preferred.

[Metallic components] based on one of the elements Fe, Co, Ni, Cu, Al, Cn, or Sn, or alloys of two or more of these elements, for example, [may be used].

The metals, more specifically the ferrites, are suitable for the inductive heating. It is further preferred that the components are homogeneously distributed in the foam. The components are preferably finely dispersed. The components, in particular the soot- or powder-like components mentioned, preferably have a size of 5 to 1000 μm intermediate values, in particular in 1-μm steps, also being hereby included in the disclosure.

The specific quantity of the components and the intensity of the heating, whether via air, electrical line, or induction, should be coordinated with one another in particular in such a way that the heating required for enabling the expansion is completed within a period of 1 to 600 seconds, preferably 1 to 300 seconds, or also within a period of 2 to 15 seconds, for example. For carrying out the heating, for example for inductive heating, an appropriate handheld device, for example a handheld inductive device, is also provided. The handheld device may be battery-powered or be provided with a plug connector. The handheld device is provided in a size and weight which allows it to be easily externally guided along a joint provided with a corresponding sealing element, or, in the case of electrical resistance heating, for connecting elements to be connected to the film element located in the sealing element, for example, resulting in the required heating for enabling the recovery of the sealing element in the course of a slow traversal or as the result of an electrically conductive connection. By means of an induction coil which is provided in the handheld device in an embodiment as an induction device, and to which a high-frequency alternating voltage is then applied, eddy currents are induced in the metallic particles which result in rapid heating of the particles and also of the compression-influencing medium as a whole. A typical power consumption of such a handheld device may be between 0.1 and 5 kW, all intermediate values of this range, in particular 0.1-kW steps, also being included in the disclosure.

The fraction of the absolute quantity of the components, in particular relative to powdered components uniformly distributed in the sealing element, may be 2 to 20 volume percent, for example, relative to the volume of the total medium contained in the sealing element. All intermediate values, in particular in 0.1% steps, are also hereby included in the disclosure. When the component is provided as a film element, a thickness in the range of 0.1 to 1 mm, for example, once again with inclusion of all intermediate values, in particular in 0.1-mm steps, is preferred. The width may correspond to or be less than the width of the sealing element. The width may also be selected in such a way that it varies over the length of the sealing element. In particular, portions may be repeatedly provided over the length of the sealing element which extend to the longitudinal edge of the sealing element or form free-standing regions. In the latter case, the regions project beyond the longitudinal edge in the direction of the width. Such regions may be used, for example, as connecting regions for the power connection, for example for a resistance heater.

A further object of the invention is a sealing element, in particular a sealing tape strip, made of an at least partially open-cell, elastically resilient foam, the sealing element being able to expand from a compressed state to an expanded state, and being permeated with an expansion-influencing medium.

The above-mentioned documents are cited as prior art. Reference is also made to the described starting point of the invention, which correspondingly also results in subject matter regarding the search for an easily handled sealing element with regard to initiation of the expansion.

With regard to the subject matter, it is an object, therefore, is to provide a foam sealing element which may be easily brought from a compressed state to a rebounded state.

This object is achieved in a further aspect of the invention in the subject matter of claim 5, the aim being to hold the sealing element in a compressed state by the medium, and to enable the expansion by the action of heat on the medium.

The characterization provided in conjunction with the above explanation of the method with regard to the sealing element is similarly of importance for the subject matter characterization of the sealing element primarily provided here, and conversely, procedural aspects are also of importance for the sealing method basically described above in this regard. This also applies, for example, to the above statements regarding a connection of the foam strips using self-adhesive strips, adhesive dots, or adhesive points.

The sealing element remains in the compressed state without further action, and without the need for an auxiliary aid such as a film which envelops the sealing element, for example. The compressed state may be discontinued only intentionally by the action of heat on the sealing element. Similarly as for the known sealing elements, this sealing element may also be present wound in rolls as delivered. In principle, a partial or complete film wrapping may also be provided.

Corresponding to the above description, this compressed state is achieved by selecting at least one essential component of the impregnation agent, with regard to a plastics having an appropriately selected (high) glass transition temperature. In this regard, reference is also made to the above discussion.

The action of heat may be provided in the manner described above. In particular, it is provided that the medium is permeated as uniformly as possible, in a finely dispersed or homogeneous manner, with components which, in particular for inductive action, are heated, which allows the glass transition temperature mentioned to be (greatly) exceeded and allows the recovery of the sealing element to begin.

In general, the invention is not limited to a sealing element. Another foam part may also be involved. In order to change the property of such a foam element impregnated with a medium, it is also not absolutely necessary for the foam element to be in a compressed state. The invention may also be of importance when a correspondingly larger quantity of impregnation agent is generally contained, or a small-cell foam is selected, and the foam element is (always) in an expanded state. By using the described medium in one of its embodiments, the property of the foam part may be changed from a quasi-rigid or very solid form to a soft and elastically deformable form, in any event for the period of time in which heating which exceeds the glass [transition] temperature is present. In the rigid state, the foam element is also able to absorb significant stresses in a manner that is atypical for elastically resilient flexible foam, without appreciable compression, for example in the range of 100 N/cm² or greater. In this regard, “appreciable” means that for such a stress the thickness decreases by 5% or less, for example in the range of 0.1 to 2%, in the direction of stress.

The invention is explained in greater detail below with reference to the accompanying drawings, which merely illustrate exemplary embodiments, as follows:

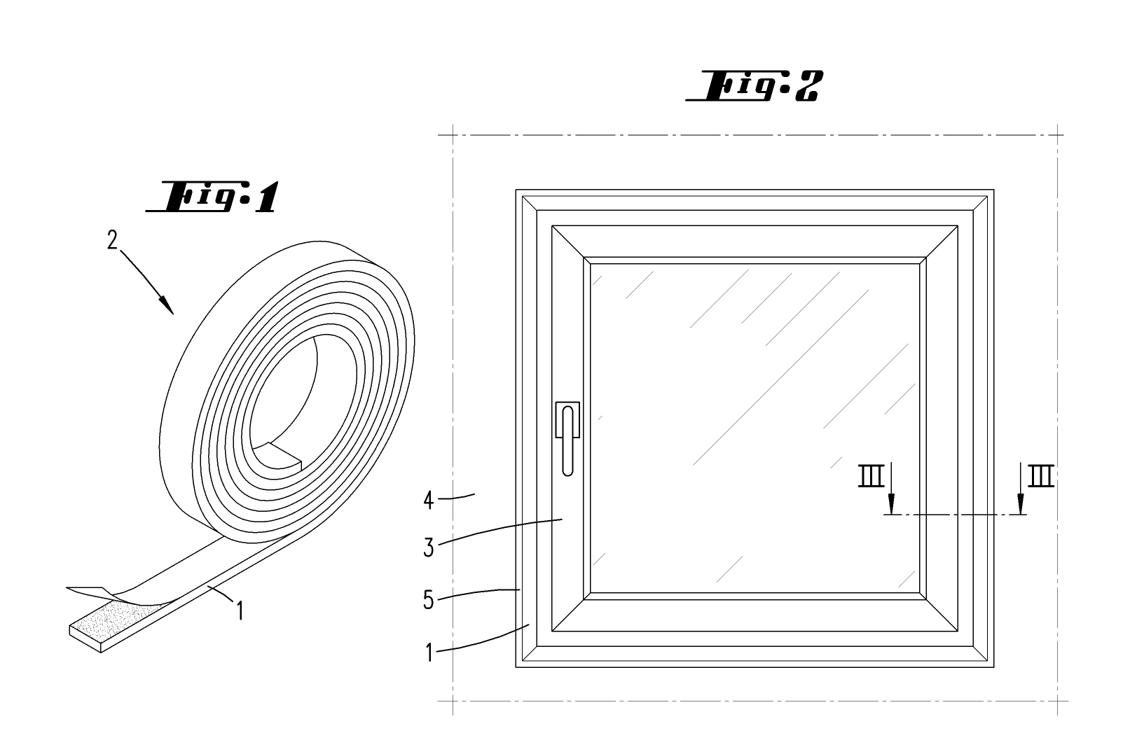

FIG. 1 shows a partially unwound sealing tape present in the form of a roll;

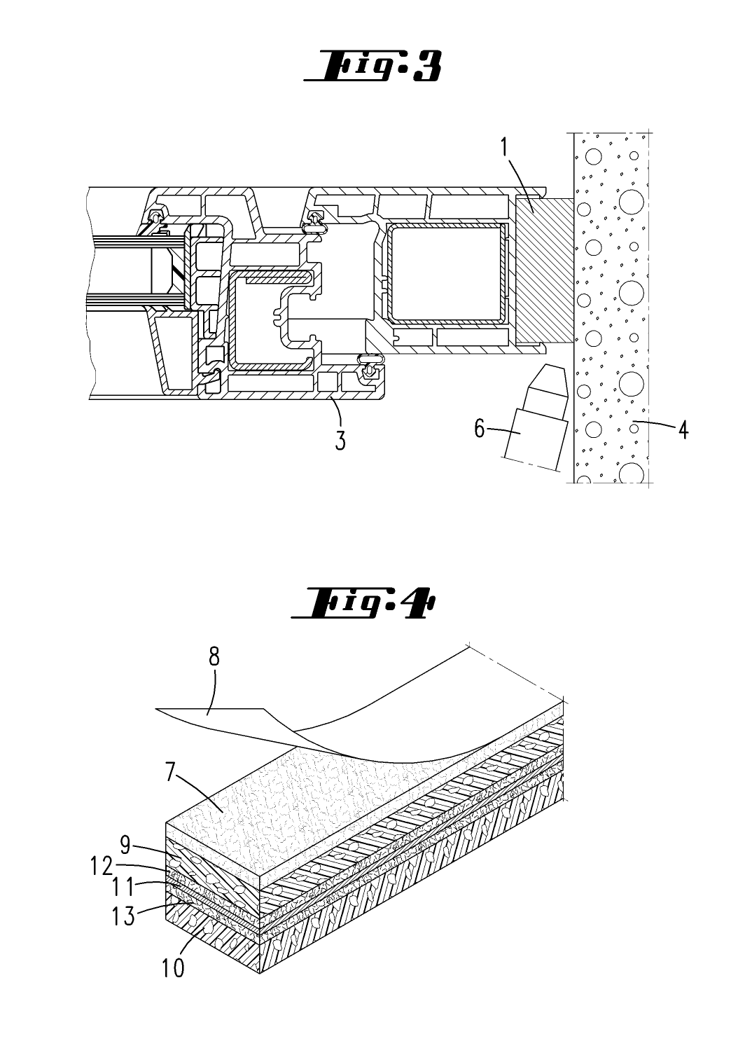

FIG. 2 shows a schematically illustrated installation situation of the sealing tapes with regard to a window;

FIG. 3 shows a cross-section of the subject matter of FIG. 2 in a section along line the sealing tape being heated using an induction device;

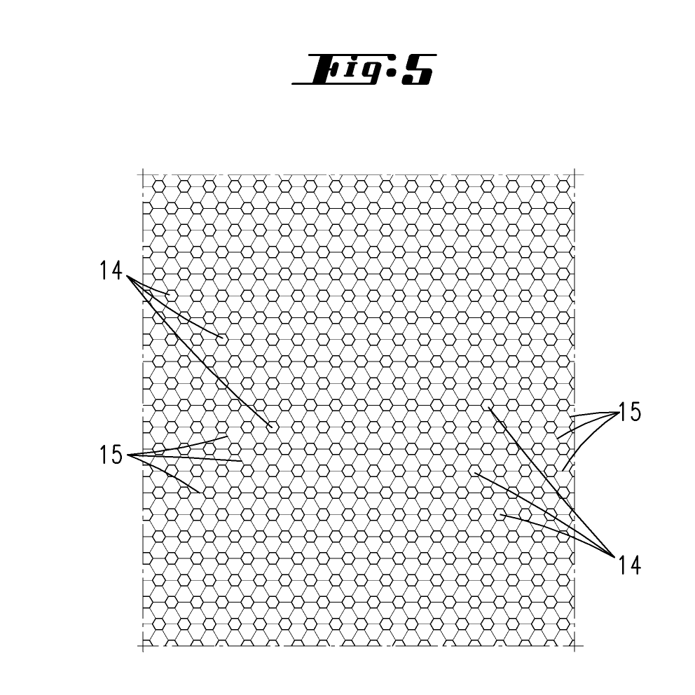

FIG. 4 shows a sealing element having a film element, in an enlarged illustration corresponding to FIG. 1; and

FIG. 5 shows an illustration of the layout of adhesive points.

A sealing tape 1 wound into a roll 2 is illustrated and described, first with reference to FIG. 1. The sealing tape is partially unwound from the roll. In contrast to customary sealing tapes which are impregnated for delayed recovery, the degree of compression, which may be in a range of 10 to 25% of the starting value, for example, is maintained after this unwinding. This is because the impregnating agent has an essential component which has a glass transition temperature that is considerably above room temperature. At this point the impregnating agent is solid to viscoplastic in such a way that the restoring forces of the flexible foam are not able to overcome the cohesion resulting from the impregnating agent.

In addition, the impregnating agent is homogeneously combined with ferritic powdered components which allow effective inductive heating of the impregnating agent.

In the subject matter of FIG. 2, the sealing tape 1 is inserted in a plurality of partial portions between a window 3 and a reveal or masonry 4. A distinct gap 5 is also provided between the window and the masonry. This is because the sealing tape 1 has a self-adhesive layer on one side by means of which in the example it is adhered to the window frame of the window 3.

It is apparent from FIG. 3 that the sealing tape 1 is heated in the installed state, using an induction device 6. The ferritic elements which are finely distributed in the impregnating agent of the sealing tape 1 are heated by the eddy current, thus heating the overall impregnating agent so that the glass transition temperature is exceeded and the (delayed) recovery of the sealing tape is enabled.

With reference to FIG. 4, another embodiment of a sealing tape, which may similarly be provided in the form of roll, is illustrated in cross-section. The thickness of the individual layers is not illustrated to scale; rather, for better understanding the thicknesses are exaggerated except for the foam layers. In a similar view as for the illustration corresponding to FIG. 1, a self-adhesive layer 7 which is covered by a cover strip 8 is provided on the top side. Located therebeneath are a first foam layer 9, and a second foam layer 10 on the bottom (with reference to the illustration). Situated between the foam layers 9, 10 is a film element 11, which has an additional self-adhesive layer 12, 13 on the top and bottom side, respectively, by which it is joined to the foam layer 9 or 10, respectively. The film layer 11, which in the exemplary embodiment is an aluminum foil layer, may be inductively heated by applying an electrical voltage, either direct-current voltage or alternating voltage. The generated heat initially heats the adjacent regions, and ultimately heats practically the entire sealing tape to the extent that the glass transition temperature of the impregnation agent is exceeded, thus enabling the recovery.

The film layer may be very thin, for example in the range of 0.001 to 0.2 mm, all intermediate values, in particular for delimitation of the stated value range from above and/or below, preferably in steps of 0.0005 mm, also being hereby included in the disclosure.

Due to the recovery, the sealing tape, which generally has a rectangular cross-section, rebounds to approximately ⅓ to ½ of its uninfluenced starting height (viewed perpendicular to the adhesive surface, i.e., in the direction transverse to the gap). The sealing tape is then in contact with both oppositely situated flanks of the gap to be sealed. However, as a result of the complete recovery being hindered in this manner, an elastic sealing contact is ensured on both sides.

FIG. 5 schematically illustrates the layout of an adhesive point pattern. Such ah adhesive point pattern may be applied to the electrical conductor, i.e., a film, for example, preferably on both sides. However, the adhesive point pattern may also be applied to a customary support for a self-adhesive strip, i.e., a nonwoven or woven fabric layer, for example. Such self-adhesive strips are then preferably situated on both sides (in the cross-section) of the electrical conductor. These self-adhesive strips then have such a point pattern or, as described above, a dot pattern (composed of adhesive) on their side facing the electrical conductor and/or on their side facing the foam. Thus, in both cases it is possible to expose the electrical conductor itself and then contact same by splitting the foam layers. Provided that the exposure is carried out while the self-adhesive strips are still adherent, a contacting element under elastic preload, for example, may be provided which reliably permeates these self-adhesive strips and thus also establishes the required electrical contact.

In particular, it is apparent that adhesive points 14 are provided which in the exemplary embodiment have a polygonal plan view, specifically, a hexagonal plan view. A multiplicity of such adhesive points 14 is connected to adjacent adhesive points, in each case via an adhesive line 15. The adhesive lines are clearly much thinner than an adhesive point. The adhesive lines have a width which corresponds to 1/10 or less, up to 1/100, of the (greatest) diameter of the adhesive point. The greatest width of an adhesive point may be between 0.5 and 5 mm, for example. The distance between two adhesive points preferably corresponds to 1/10 to 2 to 5 times the diameter of an adhesive point.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optional formulation as subordinate claims characterize an independent inventive refinement of the prior art, in particular to undertake divisional applications based on these claims.

1. A method for sealing a structural joint using a sealing element the method comprising:
providing an at least partially open-cell, elastically resilient foam that expands from a compressed state to one of partially and a completely expanded state due to an elastic resilience of the foam;
providing an expansion-influencing medium maintaining the foam in the compressed state while a temperature of the medium is below a first predetermined threshold; and
heating the medium above the first predetermined threshold temperature for expanding the foam.

2. The method according to claim 1, wherein the step of providing an expansion influencing medium includes:
providing an impregnation agent, on an acrylate basis, selected to have a glass transition temperature such that automatic recovery does not occur below the first predetermined threshold temperature.

3. The method according to claim 2, wherein the step of providing an expansion-influencing medium further includes:
providing the impregnation agent selected to have the glass transition temperature such that the first predetermined threshold temperature is about 30° C.

4. The method according to claim 3, wherein the step of providing an expansion-influencing medium further includes:
providing an impregnation agent, on an acrylate basis, selected to have a glass transition temperature such that automatic recovery occurs below a second predetermined threshold temperature of 80° C. which is higher than the first predetermined threshold temperature.

5. (canceled)

6. The method according to claim 1, wherein, the step of heating includes:
inductively heating the medium.

7. The method according to claim 1, wherein the step of heating includes:
heating the medium with electrical resistance.

8. A sealing element, including a sealing tape strip, the sealing tape strip including:
an at least partially open-cell, elastically resilient foam, the foam having an elastic resilience causing the foam to expand from a compressed state to an expanded state; and
an expansion-influencing medium permeating the foam, the foam being held in the compressed state by the medium, and the expansion occurring when the medium is heated above a predetermined threshold temperature.

9. The sealing element according to claim 8, wherein at least one of the medium and the foam includes components excitable by alternating electromagnetic fields, the components generating heat when excited.

10. The sealing element according to claim 9, wherein the components are provided in at least one of a powder-, soot-, wire-, or film-like form.

11. The sealing element according to claim 9, wherein the components include at least one of Fe, Co, Ni, Cu, Al, Cn, or Sn and an alloy including at least two of Fe, Co, Ni, Cu, Al, Cn, and Sn.

12. The sealing element according to claim 9, wherein the components may be inductively heated.

13. The sealing element according to claim 9, wherein the components are homogeneously distributed in at least one of the medium and the foam.

14. The sealing element according to claim 9, wherein the components have an average size of about 5 μm to about 1000 μm.

15. The sealing element according to claim 8, wherein the heating occurs above the predetermined threshold temperature within about 1 to about 600 seconds.

16. The sealing element according to claim 9, wherein at least one of the components has an elongated form in a longitudinal direction of the sealing element.

17. The sealing element according to claim 16, wherein the at least one component with the elongated form has a length of at least about 10 cm.

18. The sealing element according to claim 16, wherein the length of the at least one component with the elongated form is approximately the same as a length of the sealing tape.

19. The sealing element according to claim 8, wherein the medium is adhered, by means of a self-adhesive strip, between a first layer of the foam and a second layer of the foam.

20. The sealing element according to claim 8, wherein the medium has a film-like form, and self-adhesive strips are situated on both sides of the medium.

21. The sealing element according to claim 8, wherein the medium has a film-like form, and the medium includes an adhesive.

22. The sealing element according to claim 19, wherein at least one of the adhesive present on the self-adhesive strip and the medium is applied in the form of one point and a dot pattern.

23. The sealing element according to claim 8, wherein the medium is heated to above the predetermined threshold temperature within about 1 to about 300 seconds.

24. The sealing element according to claim 8, wherein the predetermined threshold temperature is above room temperature.
